(19) United States
(12) Patent Application Publication
(10) Pub. No.: US 2025/0102935 A1
(43) Pub. Date: Mar. 27, 2025

(54) ELECTROPHOTOGRAPHIC PHOTORECEPTOR FOR CONTACT CHARGING WITH DC VOLTAGE, PROCESS CARTRIDGE, AND IMAGE FORMING APPARATUS

(71) Applicant: FUJIFILM Business Innovation Corp., Tokyo (JP)

(72) Inventors: Satoshi MIZOGUCHI, Kanagawa (JP); Masaki HIRAKATA, Kanagawa (JP); Hideya KATSUHARA, Kanagawa (JP)

(73) Assignee: FUJIFILM Business Innovation Corp., Tokyo (JP)

(21) Appl. No.: 18/593,996

(22) Filed: Mar. 4, 2024

(30) Foreign Application Priority Data
Sep. 22, 2023 (JP) 2023-158284

(51) Int. Cl. G03G 7/00; G03G 15/01; G03G 15/02; G03G 21/18

(52) U.S. Cl. CPC G03G 7/002; G03G 15/0189; G03G 15/0216; G03G 21/1839; G03G 2215/00654

(57) ABSTRACT

An electrophotographic photoreceptor for contact charging with a DC voltage, includes a conductive substrate, an undercoat layer provided on the conductive substrate, a charge generation layer provided on the undercoat layer, a charge transport layer provided on the charge generation layer, and a surface protective layer provided on the charge transport layer, in which the surface protective layer is a cured film of a composition containing a reactive charge transport material and contains a hydroxy group and a benzene ring structure, and a value of a peak area of the hydroxy group/a peak area of the benzene ring structure that are measured by an attenuated total reflection method of infrared spectroscopy, is greater than 0.05 and 0.36 or less.

### CROSS-REFERENCE TO RELATED APPLICATIONS

This application is based on and claims priority under 35 USC 119 from Japanese Patent Application No. 2023-158284 filed Sep. 22, 2023.

### BACKGROUND

### (i) Technical Field

The present invention relates to an electrophotographic photoreceptor for contact charging with a DC voltage, a process cartridge, and an image forming apparatus.

### (ii) Related Art

JP2000-314980A discloses an electrophotographic photoreceptor including at least one photosensitive layer on a conductive support, in which at least an outermost surface layer in the photosensitive layer consists of a crosslinked cured film formed of a compound (I) represented by General Formula (A) and a compound (II) represented by General Formula (B) and having a plurality of substituents, the crosslinked cured film is formed such that a content ratio A of a residual OH group defined by Equation (1) is 2.0 or less and a content ratio B of a residual OH group defined by Equation (2) is 0.3 or less.

F-D-Si(R¹)₍₃₋ₐ₎(OR²)ₐ General formula (A)

(In the formula, F represents a photoelectric subunit, D represents a flexible subunit, R¹ represents a hydrogen atom, an alkyl group, or a substituted or unsubstituted aryl group, and R² represents a hydrogen atom, an alkyl group, or a trialkylsilyl group, and a represents an integer of 1 to 3.)

—Si(R³)_{(3-b)}(OR⁴)_{b} General formula (B)

(In the formula, R³ represents a hydrogen atom, an alkyl group, a substituted or unsubstituted aryl group, R⁴ represents a hydrogen atom, an alkyl group, or a trialkylsilyl group, and b represents an integer of 1 to 3.)

$$A = x 1 / y \qquad ( 1 )$$

$$B = x 2 / y \qquad ( 2 )$$

(In the equations, x1 represents an absorbance of an infrared absorption peak at 3500 to 3300 cm⁻¹ based on OH stretching vibration, x2 represents an absorbance of an infrared absorption peak at 955 to 890 cm⁻¹ based on OH stretching vibration, and y represents an absorbance of an infrared absorption peak at 1740 to 1700 cm⁻¹ based on CO stretching vibration of a carbonyl bond.)

### SUMMARY

Aspects of non-limiting embodiments of the present disclosure relate to an electrophotographic photoreceptor for contact charging with a DC voltage that includes a conductive substrate, an undercoat layer, a charge generation layer, a charge transport layer, and a surface protective layer, in which the surface protective layer is a cured film of a composition containing a reactive charge transport material, and the electrophotographic photoreceptor has an excellent property of suppressing abrasion and an excellent property of suppressing image deletion as compared with a case where a value of a peak area of a hydroxy group/a peak area of a benzene ring structure that are measured by an attenuated total reflection method of infrared spectroscopy, is 0.05 or less or greater than 0.36 in a case where the electrophotographic photoreceptor is contact-charged with a DC voltage.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above-described object includes the following aspects.

According to an aspect of the present disclosure, there is provided an electrophotographic photoreceptor for contact charging with a DC voltage, including: a conductive substrate; an undercoat layer provided on the conductive substrate; a charge generation layer provided on the undercoat layer; a charge transport layer provided on the charge generation layer; and a surface protective layer provided on the charge transport layer, in which the surface protective layer is a cured film of a composition containing a reactive charge transport material and contains a hydroxy group and a benzene ring structure, and a value of a peak area of the hydroxy group/a peak area of the benzene ring structure that are measured by an attenuated total reflection method of infrared spectroscopy, is greater than 0.05 and 0.36 or less.

### BRIEF DESCRIPTION OF THE DRAWINGS

Exemplary embodiment(s) of the present invention will be described in detail based on the following figures, wherein:

FIG. 1 is a schematic partial cross-sectional view showing an example of a layer configuration of an electrophotographic photoreceptor according to the present exemplary embodiment;

FIG. 2 is a schematic configuration view showing an example of an image forming apparatus according to the present exemplary embodiment; and

FIG. 3 is a schematic configuration view showing another example of the image forming apparatus according to the present exemplary embodiment.

### DETAILED DESCRIPTION

The present exemplary embodiment will be described below. The following descriptions and examples merely illustrate the exemplary embodiments, and do not limit the scope of the exemplary embodiments.

In the present specification, a numerical range shown using “to” indicates a range including numerical values described before and after “to” as a minimum value and a maximum value.

In a numerical range described in a stepwise manner in the present specification, an upper limit value or a lower limit value described in a certain numerical range may be replaced with an upper limit value or a lower limit value in another numerical range described in a stepwise manner. Further, in a numerical range described in the present specification, an upper limit value or a lower limit value described in the numerical range may be replaced with a value shown in an example.

In the present specification, the meaning of the term “step” includes not only an independent step but also a step whose intended purpose is achieved even in a case where the step is not clearly distinguished from other steps.

In the present specification, each component may include a plurality of kinds of substances corresponding to each component. In the present specification, in a case where a plurality of kinds of substances corresponding to each component in a composition are present, the amount of each component in the composition indicates the total amount of the plurality of kinds of substances present in the composition unless otherwise specified.

In the present specification, the main component denotes a major component. In the present specification, the main component denotes a component that occupies 30% by mass or greater of the total mass of a mixture obtained by mixing a plurality of kinds of components.

Electrophotographic Photoreceptor for Contact Charging with DC Voltage

An electrophotographic photoreceptor for contact charging with a DC voltage according to the present exemplary embodiment (hereinafter, also simply referred to as “electrophotographic photoreceptor” or “photoreceptor”) includes a conductive substrate, an undercoat layer provided on the conductive substrate, a charge generation layer provided on the undercoat layer, a charge transport layer provided on the charge generation layer, and a surface protective layer provided on the charge transport layer, in which the surface protective layer is a cured film of a composition containing a reactive charge transport material and contains a hydroxy group and a benzene ring structure, and a value of a peak area of the hydroxy group/a peak area of the benzene ring structure that are measured by an attenuated total reflection method of infrared spectroscopy, is greater than 0.05 and 0.36 or less.

In a case where an electrophotographic photoreceptor of the related art which has a surface protective layer on the outermost surface in order to maintain the quality for a long period of time is contact-charged with a DC voltage, the surface protective layer is unlikely to be abraded in a case of being hardened, but the amount of an adhered discharge product to be scraped off is decreased so that a defect of image deletion is likely to occur, and thus a certain degree of abrasion occurs. Therefore, both a property of suppressing abrasion and a property of suppressing image deletion are difficult to achieve.

In the electrophotographic photoreceptor for contact charging with a DC voltage according to the present exemplary embodiment, it is assumed that in a case where the value of the peak area of the hydroxy group/the peak area of the benzene ring structure of the surface protective layer that are measured by an attenuated total reflection method of infrared spectroscopy, is greater than 0.05 and 0.36 or less, the hydroxy group in the surface protective layer is crosslinked so that the amount of the hydroxy group is reduced, the hardness is improved so that the abrasion is reduced, adhesion of water to the surface of the electrophotographic photoreceptor is suppressed because the amount of the hydroxy group serving as a hydrophilic group is small, combining of water and a discharge product and adhesion of the combined water and the discharge product to the surface of the electrophotographic photoreceptor are suppressed so that the amount of the adhered discharge product is reduced, occurrence of image deletion caused by water and the discharge product is suppressed, and thus the property of suppressing abrasion and the property of suppressing image deletion are excellent.

Hereinafter, the layer configuration of the electrophotographic photoreceptor according to the present exemplary embodiment will be described with reference to the accompanying drawings.

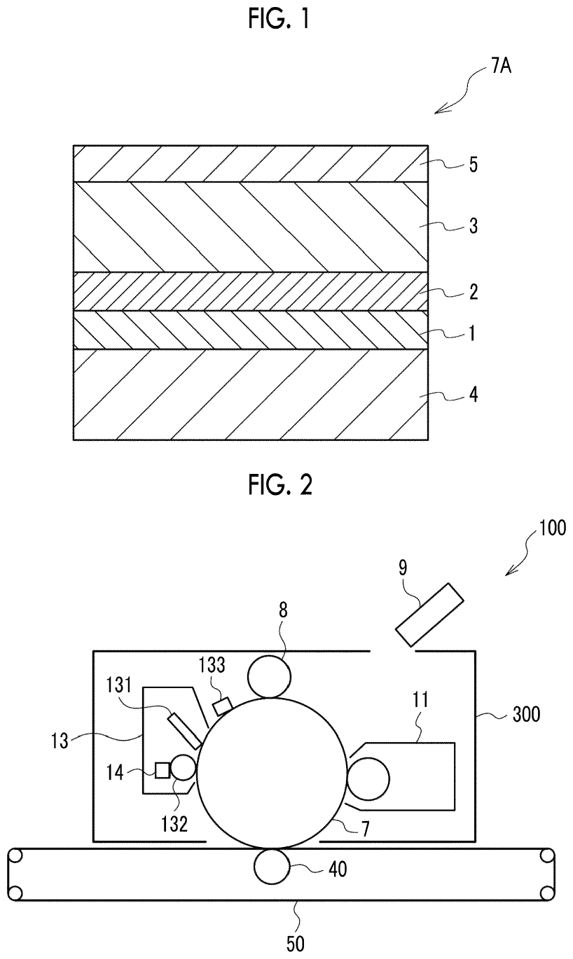

FIG. 1 is a schematic cross-sectional view showing an example of the layer configuration of the electrophotographic photoreceptor according to the present exemplary embodiment.

A photoreceptor 7A shown in FIG. 1 has a structure in which an undercoat layer 1, a charge generation layer 2, a charge transport layer 3, and a surface protective layer 5 are laminated in this order on a conductive substrate 4. The charge generation layer 2 and the charge transport layer 3 constitute a photosensitive layer. The surface protective layer 5 is a cured film of a composition containing a reactive charge transport material and contains a hydroxy group and a benzene ring structure, and the value of the peak area of the hydroxy group/the peak area of the benzene ring structure that are measured by an attenuated total reflection method of infrared spectroscopy, is greater than 0.05 and 0.36 or less.

In the electrophotographic photoreceptor according to the present exemplary embodiment, the photosensitive layer is a function separation type photosensitive layer in which the charge generation layer 2 and the charge transport layer 3 are separated as in the photoreceptor 7A shown in FIG. 1. The electrophotographic photoreceptor may include layers other than the above-described layers.

Hereinafter, each layer of the electrophotographic photoreceptor according to the present exemplary embodiment will be described in detail.

### Surface Protective Layer

The surface protective layer is provided on the charge transport layer.

The surface protective layer is a cured film of a composition that contains a reactive charge transport material containing a reactive group and a charge-transporting skeleton in an identical molecule.

Further, the surface protective layer contains a hydroxy group and a benzene ring structure, and the value of the peak area of the hydroxy group/the peak area of the benzene ring structure that are measured by an attenuated total reflection method of infrared spectroscopy, is greater than 0.05 and 0.36 or less.

The surface protective layer contains a hydroxy group. The hydroxy group may be an alcoholic hydroxy group (=a hydroxy group directly bonded to an aliphatic group) or a phenolic hydroxy group (=a hydroxy group directly bonded to an aromatic group), but it is preferable that the surface protective layer contains, for example, an alcoholic hydroxy group from the viewpoint that the nucleophilicity of the hydroxy group is high and the amount of the hydroxy group that is present is further reduced.

The surface protective layer has a benzene ring structure. The substituent on the benzene ring is not particularly limited, and the benzene rings may be bonded to each other as in the biphenyl structure.

The surface protective layer contains a hydroxy group and a benzene ring structure, and the value of the peak area of the hydroxy group/the peak area of the benzene ring structure that are measured by an attenuated total reflection method (ATR method) of infrared spectroscopy (FT-IR analysis) is greater than 0.05 and 0.36 or less, for example, preferably 0.07 or greater and 0.36 or less, more preferably 0.10 or greater and 0.30 or less, and particularly preferably 0.12 or greater and 0.25 or less from the viewpoint of the property of suppressing abrasion and the property of suppressing image deletion.

The value of the peak area of the hydroxy group/the peak area of the benzene ring structure that are measured by an attenuated total reflection method of infrared spectroscopy, is measured by the following method.

### Measurement Conditions for Infrared Spectroscopy

Device: Frontier (manufactured by PerkinElmer, Inc.)
ATR crystal: Ge
Resolution: 4 cm⁻¹
Number of times of scanning: 32 times

The spectrum is ATR-corrected.

### —Peak Position—

OH group: 3450 cm⁻¹
Base line: drawn at 3705 cm⁻¹ to 3257 cm⁻¹
Benzene ring structure: 820 cm⁻¹
Base line: drawn at 882 cm⁻¹ to 776 cm⁻¹

The area of the site surrounded by the base line is calculated.

The area of the OH group area/the area of the benzene ring structure area is used as an index of the amount of the residual OH group.

The surface protective layer is a layer formed of a cured film of a composition that contains a reactive charge transport material containing a reactive group and a charge-transporting skeleton in an identical molecule (that is, a layer containing a polymer or a crosslinked body of the reactive charge transport material).

Further, the surface protective layer may further contain a non-reactive charge transport material.

Examples of the reactive group of the reactive charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 or greater and 3 or less]. Further, examples of the reactive group in the reactive group-containing non-charge transport material include the above-described known reactive groups.

The chain polymerizable group is not particularly limited as long as the group is a functional group capable of radical polymerization and is, for example, a functional group containing a group having at least a carbon double bond. Specific examples thereof include a vinyl group, a vinyl ether group, a vinyl thioether group, a styryl group, an acryloyl group, a methacryloyl group, and a group containing at least one selected from derivatives thereof. Among these, from the viewpoint that the reactivity is excellent, for example, a vinyl group, a styryl group (vinylphenyl group), an acryloyl group, a methacryloyl group, and a group containing at least one selected from derivatives thereof are preferable as the chain polymerizable group.

Among the examples, from the viewpoints of the property of suppressing abrasion and the property of suppressing image deletion, the reactive group of the reactive charge transport material is, for example, preferably a chain polymerizable group, an epoxy group, —OH, —OR, —NH₂, or —SH, more preferably —OH, —OR, —NH₂, or —SH, still more preferably —OH or —OR, and particularly preferably —OH.

The charge-transporting skeleton is not particularly limited as long as the charge-transporting skeleton is a known structure in an image holding member, and examples thereof include a structure conjugated with a nitrogen atom, which is a skeleton derived from a nitrogen-containing positive hole-transporting compound such as a triarylamine-based compound (compound having a triarylamine skeleton), a benzidine-based compound (compound having a benzidine skeleton), or a hydrazone-based compound (compound having a hydrazone skeleton). Among these, from the viewpoints of the charge transport properties, the property of suppressing abrasion, and the property of suppressing image deletion, it is preferable that the reactive charge transport material has, for example, a triarylamine skeleton as the charge-transporting skeleton.

The reactive charge transport material having the reactive group and the charge-transporting skeleton, the non-reactive charge transport material, and the reactive non-charge transport material may be selected from known materials.

The reactive charge transport material may be a reactive charge transport material containing a hydroxy group as a reactive group (hereinafter, also referred to as “specific reactive charge transport material (a)”). The reactive non-charge transport material may be used alone or in combination of two or more kinds thereof.

For example, a compound represented by Formula (A) is preferable as the specific reactive charge transport material (a) from the viewpoint that the charge transport properties are excellent.

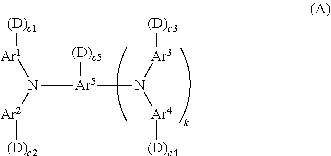

In Formula (A), Ar¹ to Ar⁴ each independently represent a substituted or unsubstituted aryl group, Ar⁵ represents a substituted or unsubstituted aryl group or a substituted or unsubstituted arylene group, D represent an organic group containing a hydroxy group, c1 to c5 each independently represent an integer of 0 or greater and 2 or less, k represents 0 or 1, d represents an integer of 0 or greater and 5 or less, e represents 0 or 1, and the total number of D's is 4 or greater.

In Formula (A), Ar¹ to Ar⁴ each independently represent a substituted or unsubstituted aryl group. Ar¹ to Ar⁴ may be the same as or different from each other.

Here, examples of the substituent in the substituted aryl group include an alkyl group or an alkoxy group having 1 to 4 carbon atoms and a substituted or unsubstituted aryl group having 6 or more and 10 or less carbon atoms in addition to the organic group containing a hydroxy group as D.

It is preferable that Ar¹ to Ar⁴ are represented by, for example, any of Formulae (1) to (7). Further, Formulae (1) to (7) show “-(D)_{C}” generally representing “-(D)_{C1}” to “-(D)_{C4}” that can be linked to each of Ar¹ to Ar⁴.

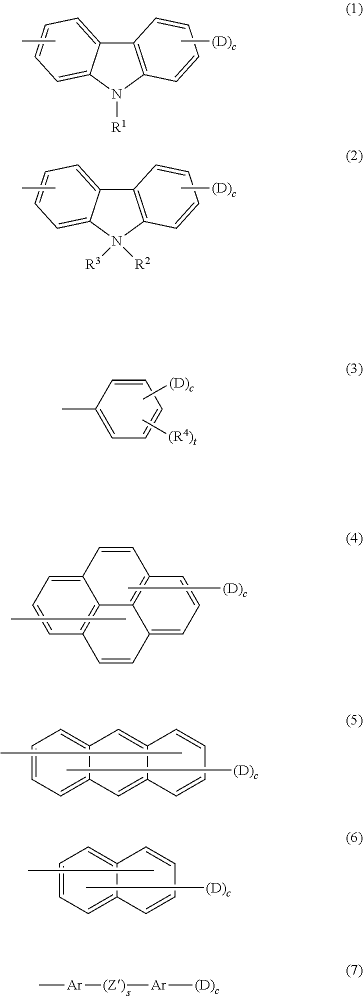

In Formulae (1) to (7), R¹ represents one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, R² to R⁴ each independently represent one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, Ar represents a substituted or unsubstituted arylene group, D represents an organic group containing a hydroxy group, c represents 1 or 2, s represents 0 or 1, and t represents an integer of 0 or greater and 3 or less.

Here, it is preferable that Ar in Formula (7) is represented by, for example, Structural Formula (8) or (9).

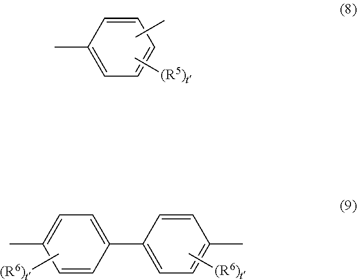

In Formulae (8) and (9), R⁵ and R⁶ each independently represent one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, and each t′ represents an integer of 0 or greater and 3 or less.

Further, in Formula (7), Z′ represents a divalent organic linking group and, for example, preferably a group represented by any of Formulae (10) to (17). Further, in Formula (7), s′ each represents 0 or 1.

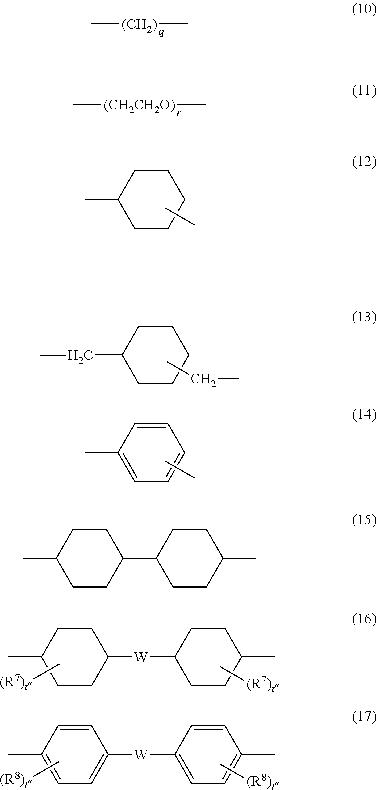

In Formulae (10) to (17), R⁷ and R⁸ each independently represent one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, W represents a divalent group, q and r each independently represent an integer of 1 or greater and 10 or less, and each t″ independently represents an integer of 0 or greater and 3 or less.

It is preferable that W in Formulae (16) to (17) is, for example, represented by any of the divalent groups represented by Formulae (18) to (26). Here, in Formula (25), u represents an integer of 0 or greater and 3 or less.

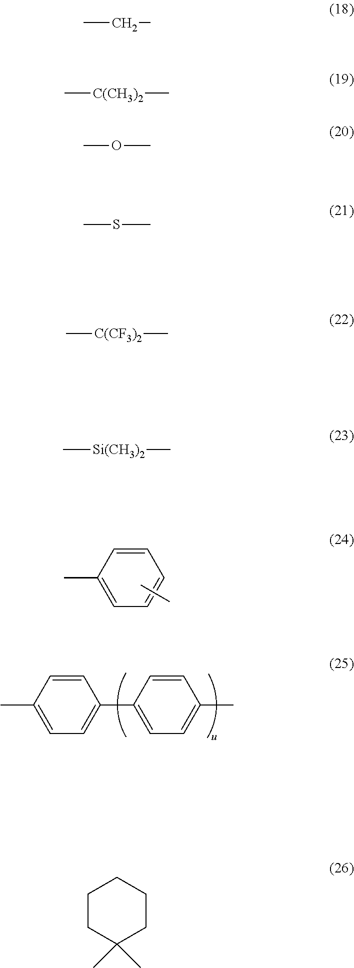

Further, in Formula (A), Ar⁵ represents a substituted or unsubstituted aryl group in a case where k represents 0, and examples of the aryl group include the same groups as the groups for the aryl group exemplified in the description of Ar¹ to Ar⁴. Further, Ar⁵ represents a substituted or unsubstituted arylene group in a case where k represents 1, and examples of the arylene group include an arylene group obtained by removing one hydrogen atom at a position where —N(Ar³⁻(D)_{C3})(Ar⁴⁻(D)_{C4}) is substituted from the aryl group exemplified in the description of Ar¹ to Ar⁴.

The content of the reactive charge transport material is, for example, preferably 30% by mass or greater and 100% by mass or less, more preferably 40% by mass or greater and 100% by mass or less, and still more preferably 50% by mass or greater and 100% by mass or less with respect to the composition (solid content) used for forming the surface protective layer. In a case where the content thereof is set to be in the above-described ranges, the electrical properties of the cured film are excellent, and the cured film can be thickened.

Examples of the non-reactive charge transport material include electron-transporting compounds, for example, a quinone-based compound such as p-benzoquinone, chloranil, bromanil, or anthraquinone; a tetracyanoquinodimethane-based compound; a fluorenone compound such as 2,4,7-trinitrofluorenone; a xanthone-based compound; a benzophenone-based compound; a cyanovinyl-based compound; and an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. The non-reactive charge transport material may be used alone or in combination of two or more kinds thereof.

Among these, examples of the non-reactive charge transport material include a triarylamine-based compound from the viewpoints of the property of suppressing abrasion and the property of suppressing image deletion.

From the viewpoints of the property of suppressing abrasion and the property of suppressing image deletion, the surface protective layer is, for example, preferably a cured film of a composition that contains a compound containing a hydroxy group and a compound containing no hydroxy group and having a benzene ring structure and more preferably a cured film of a composition that contains a compound containing a hydroxy group and having a benzene ring structure and a compound containing no hydroxy group and having a benzene ring structure.

From the viewpoints of the property of suppressing abrasion and the property of suppressing image deletion, the compound containing a hydroxy group is, for example, preferably a reactive charge transport material containing a reactive group and a charge-transporting skeleton and more preferably a reactive charge transport material containing a hydroxy group and a charge-transporting skeleton.

Further, from the viewpoints of the charge transport properties, the property of suppressing abrasion, and the property of suppressing image deletion, it is preferable that the compound containing a hydroxy group is, for example, a compound having a triarylamine structure.

From the viewpoints of the property of suppressing abrasion and the property of suppressing image deletion, the compound containing no hydroxy group and having a benzene ring structure is, for example, preferably a reactive charge transport material containing a reactive group and a charge-transporting skeleton and more preferably a reactive charge transport material containing an alkoxy group and a charge-transporting skeleton.

From the viewpoints of the charge transport properties, the property of suppressing abrasion, and the property of suppressing image deletion, it is preferable that the compound containing no hydroxy group and having a benzene ring structure is, for example, a compound having a triarylamine structure.

From the viewpoints of the property of suppressing abrasion and the property of suppressing image deletion, a value of a mass ratio MH/MB of a content MH of the compound containing a hydroxy group to a content MB of the compound containing no hydroxy group and having a benzene ring structure in the composition forming the cured film is, for example, preferably 2 or greater and 30 or less, more preferably 3 or greater and 25 or less, still more preferably 5 or greater and 20 or less, and particularly preferably 5 or greater and 10 or less.

From the viewpoints of the property of suppressing abrasion and reducing the hygroscopicity to improve the property of suppressing image deletion, it is preferable that the surface protective layer contains, for example, no carboxy group.

Further, from the viewpoints of the property of suppressing abrasion and reducing the hygroscopicity to improve the property of suppressing image deletion, the surface protective layer contains, for example, preferably no silicon atom and more preferably no carboxy group and no silicon atom.

Examples of the reactive non-charge transport material include a thermosetting resin and a curing agent. The reactive group-containing non-charge transport material may be used alone or in combination of two or more kinds thereof.

Examples of the thermosetting resin include a guanamine resin, a melamine resin, a phenol resin, a urea resin, and an alkyd resin.

Examples of the curing agent include a compound having a guanamine structure (hereinafter, also referred to as “guanamine compound”) and a compound having a melamine structure (hereinafter, also referred to as “melamine compound”).

In a case where the surface protective layer is, for example, a cured film formed to contain at least one crosslinked body (crosslinked material) selected from the group consisting of a reactive charge transport material, a thermosetting resin (for example, more preferably a guanamine resin or a melamine resin), a guanamine compound, and a melamine compound, a cured film having a high curing degree is likely to be obtained and the property of suppressing abrasion is more excellent as compared with a case where the surface protective layer does not contain a thermosetting resin (for example, more preferably a guanamine resin or a melamine resin), a guanamine compound, and a melamine compound.

The surface protective layer may further contain fluororesin particles.

In a case where the surface protective layer contains fluororesin particles, the outer peripheral surface of the surface protective layer is roughened as appropriate, and the property of suppressing abrasion is more excellent.

The content of the fluororesin particles in the surface protective layer is 5% by mass or greater and 15% by mass or less with respect to the total solid content of the surface protective layer.

The content of the fluororesin particles is, for example, preferably 5% by mass or greater and 15% by mass or less and more preferably 7% by mass or greater and 12% by mass or less with respect to all the components constituting the layer (the total amount of the solid content).

The fluororesin particles are not particularly limited, and examples thereof include particles such as polytetrafluoroethylene (PTFE, also referred to as “ethylene tetrafluoride resin”), a perfluoroalkoxy fluororesin, polychlorotrifluoroethylene, polyvinylidene fluoride, polydichlorodifluoroethylene, a tetrafluoroethylene-perfluoroalkyl vinyl ether copolymer, a tetrafluoroethylene-hexafluoropropylene copolymer, a tetrafluoroethylene-ethylene copolymer, a tetrafluoroethylene-hexafluoropropylene-perfluoroalkyl vinyl ether copolymer, and a tetrafluoroethylene-perfluoroalkoxy ethylene copolymer.

Among these, from the viewpoints of the property of suppressing abrasion and the cleaning properties of the electrophotographic photoreceptor, for example, polytetrafluoroethylene and a copolymer of tetrafluoroethylene and perfluoroalkoxyethylene are desirable.

The fluororesin particles may be used alone or in combination of two or more kinds thereof.

The weight-average molecular weight of the fluororesin constituting the fluororesin particles is, for example, preferably 3000 or greater and 5000000 or less.

The average primary particle diameter of the fluororesin particles is, for example, preferably 0.05 μm or greater and 10 μm or less and more preferably 0.1 μm or greater and 5 μm or less.

Further, the average primary particle diameter of the fluororesin particles denotes a value obtained by measuring a measurement liquid at a refractive index of 1.35 which has been diluted with the same solvent as the solvent for a dispersion liquid in which fluororesin particles are dispersed, using a laser diffraction/scattering type particle size distribution measuring device LA-920 (manufactured by Horiba, Ltd.).

Examples of commercially available products of the fluororesin particles include LUBRON (registered trademark) Series (manufactured by Daikin Industries, Ltd.), TEFLON (registered trademark) Series (manufactured by DuPont), and DYNION Series (manufactured by Sumitomo 3M Ltd.).

### Method of Forming Surface Protective Layer

The formation of the surface protective layer is not particularly limited, and a known forming method is used, and preferred examples thereof include a method of forming a coating film of a coating solution (=the composition described above) for forming a surface protective layer in which the above-described components are added to a solvent, drying the coating film, and performing a curing treatment such as heating as necessary.

From the viewpoints of the hardness of the coating film, the property of suppressing abrasion, and the property of suppressing image deletion, the drying temperature in a case of drying the coating film is, for example, preferably 150° C. or higher, more preferably 150° C. or higher and 200° C. or lower, still more preferably 150° C. or higher and 180° C. or lower, and particularly preferably 155° C. or higher and lower than 170° C.

Further, the drying time in the case of drying the coating film is also related to the drying temperature, but is, for example, preferably 10 minutes or longer, more preferably 20 minutes or longer, still more preferably 20 minutes or longer and 120 minutes or shorter, and particularly preferably 20 minutes or longer and 60 minutes or shorter from the viewpoints of the hardness of the coating film, the property of suppressing abrasion, and the property of suppressing image deletion.

Examples of the solvent for preparing the coating solution for forming a surface protective layer include an aromatic solvent such as toluene or xylene; a ketone-based solvent such as methyl ethyl ketone, methyl isobutyl ketone, or cyclohexanone; an ester-based solvent such as ethyl acetate or butyl acetate; an ether-based solvent such as tetrahydrofuran or dioxane; a cellosolve-based solvent such as ethylene glycol monomethyl ether; and an alcohol-based solvent such as isopropyl alcohol or butanol. These solvents are used alone or in the form of a mixture of two or more kinds thereof.

The content of the solvent is, for example, preferably 30% by mass or greater and 95% by mass or less, more preferably 50% by mass or greater and 90% by mass or less, and particularly preferably 60% by mass or greater and 80% by mass or less with respect to the total mass of the coating solution for forming a surface protective layer.

Examples of the method of coating the photosensitive layer (such as the charge transport layer) with the coating solution for forming a surface protective layer include typical methods such as a dip coating method, a push-up coating method, a wire bar coating method, a spray coating method, a blade coating method, an air knife coating method, and a curtain coating method.

### Film Thickness

The film thickness of the surface protective layer is set to be, for example, preferably in a range of 1 μm or greater and 20 μm or less and more preferably in a range of 2 μm or greater and 10 μm or less.

### Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited, or laminated with a conductive compound (such as a conductive polymer or indium oxide), a metal (such as aluminum, palladium, or gold), or an alloy. Here, the term “conductive” denotes that the volume resistivity is less than 10¹³ Ω·cm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. Further, in a case where incoherent light is used as a light source, roughening of the surface to prevent interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the micropores of the oxide film are closed by volume expansion due to a hydration reaction in pressurized steam or boiling water (a metal salt such as nickel may be added thereto) for a change into a more stable hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid to the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by dipping the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 10² Ω·cm or greater and 10¹¹ Ω·cm or less.

Among these, as the inorganic particles having the above-described resistance value, for example, metal oxide particles such as tin oxide particles, titanium oxide particles, zinc oxide particles, and zirconium oxide particles may be used, and zinc oxide particles are particularly preferable.

The specific surface area of the inorganic particles measured by the BET method may be, for example, 10 m²/g or greater.

The volume average particle diameter of the inorganic particles may be, for example, 50 nm or greater and 2000 nm or less (for example, preferably 60 nm or greater and 1000 nm or less).

The content of the inorganic particles is, for example, preferably 10% by mass or greater and 80% by mass or less and more preferably 40% by mass or greater and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-N-2-(aminoethyl)-3-(aminoethyl)-3-aminopropyltrimethoxysilane, aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

Here, the undercoat layer may contain an electron-accepting compound (acceptor compound) together with the inorganic particles, for example, from the viewpoint of enhancing the long-term stability of the electrical properties and the carrier blocking properties.

Examples of the electron-accepting compound include electron-transporting substances, for example, a quinone-based compound such as chloranil or bromanil; a tetracyanoquinodimethane-based compound; a fluorenone compound such as 2,4,7-trinitrofluorenone or 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole; a xanthone-based compound; a thiophene compound; and a diphenoquinone compound such as 3,3′,5,5′-tetra-t-butyldiphenoquinone.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable, and specifically, for example, anthraquinone, alizarin, quinizarin, anthrarufin, or purpurin is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of each inorganic particle by adding the electron-accepting compound dropwise to inorganic particles directly or by dissolving the electron-accepting compound in an organic solvent while stirring the inorganic particles with a mixer having a large shearing force and spraying the mixture together with dry air or nitrogen gas. The electron-accepting compound may be added dropwise or sprayed, for example, at a temperature lower than or equal to the boiling point of the solvent. After the dropwise addition or the spraying of the electron-accepting compound, the compound may be further baked at 100° C. or higher. The baking is not particularly limited as long as the temperature and the time are adjusted such that the electrophotographic characteristics can be obtained.

The wet method is, for example, a method of attaching the electron-accepting compound to the surface of each inorganic particle by adding the electron-accepting compound to inorganic particles while dispersing the inorganic particles in a solvent using a stirrer, ultrasonic waves, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that the electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

Further, the electron-accepting compound may be attached to the surface before or after the inorganic particles are subjected to a surface treatment with a surface treatment agent or simultaneously with the surface treatment performed on the inorganic particles with a surface treatment agent.

The content of the electron-accepting compound may be, for example, 0.01% by mass or greater and 20% by mass or less and preferably 0.01% by mass or greater and 10% by mass or less with respect to the amount of the inorganic particles.

Examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reacting a curing agent with at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additives include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

The surface roughness (ten-point average roughness) of the undercoat layer may be adjusted, for example, to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles when preparing the coating solution for forming an undercoat layer include known methods such as a roll mill, a ball mill, a vibration ball mill, an attritor, a sand mill, a colloid mill, and a paint shaker.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

The film thickness of the undercoat layer is set to be, for example, preferably in a range of 15 μm or greater and more preferably in a range of 20 μm or greater and 50 μm or less.

### Interlayer

Although not shown in the figures, an interlayer may be further provided between the undercoat layer and the charge generation layer.

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical methods such as a dip coating method, a push-up coating method, a wire bar coating method, a spray coating method, a blade coating method, an air knife coating method, and a curtain coating method.

The film thickness of the interlayer is set to be, for example, preferably in a range of 0.1 μm or greater and 3 μm or less. Further, the interlayer may be used as the undercoat layer.

### Charge Generation Layer

The charge generation layer is, for example, a layer containing a charge generation material and a binder resin. Further, the charge generation layer may be a deposition layer of the charge generation material. The deposition layer of the charge generation material is, for example, preferable in a case where an incoherent light source such as a light emitting diode (LED) or an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine, chlorogallium phthalocyanine, dichlorotin phthalocyanine, and titanyl phthalocyanine are more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near ultraviolet region.

The above-described charge generation material may also be used even in a case where an incoherent light source such as an LED or an organic EL image array having a center wavelength of light emission at 450 nm or greater and 780 nm or less is used.

Meanwhile, in a case where an n-type semiconductor such as a fused ring aromatic pigment, a perylene pigment, or an azo pigment is used as the charge generation material, a dark current is unlikely to be generated, and image defects referred to as black spots can be suppressed even in a case where a thin film is used as the photosensitive layer.

Further, the n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 10¹³ Ω·cm or greater.

These binder resins may be used alone or in the form of a mixture of two or more kinds thereof.

Further, the blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. Further, the charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The film thickness of the charge generation layer is set to be, for example, preferably in a range of 0.1 μm or greater and 5.0 μm or less and more preferably in a range of 0.2 μm or greater and 2.0 μm or less.

### Charge Transport Layer

The charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone compound; a benzophenone-based compound; a cyanovinyl-based compound; and an electron-transporting compound such as an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. These charge transport materials may be used alone or in combination of two or more kinds thereof, but are not limited thereto.

From the viewpoint of the charge mobility, for example, a triarylamine derivative represented by Structural Formula (a-1) or a benzidine derivative represented by Structural Formula (a-2) is preferable as the charge transport material.

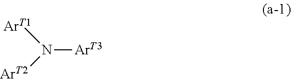

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

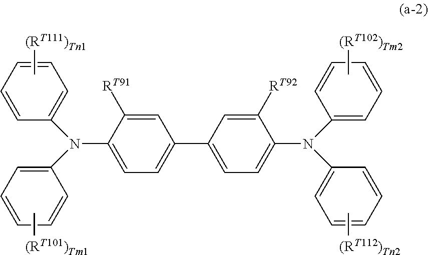

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH—CH—CH═C(R^{T15})(R^{T16}), and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or greater and 2 or less.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” and a benzidine derivative having “—CH═CH—CH═C(R^{T15})(R^{T16})” are particularly preferable from the viewpoint of the charge mobility.

As the polymer charge transport material, known materials having charge transport properties, such as poly-N-vinylcarbazole and polysilane, can be used. Particularly, for example, a polyester-based polymer charge transport material is particularly preferable. Further, the polymer charge transport material may be used alone or in combination of binder resins.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among these, for example, a polycarbonate resin or a polyarylate resin is preferable as the binder resin. These binder resins may be used alone or in combination of two or more kinds thereof.

Further, the blending ratio between the charge transport material and the binder resin is, for example, preferably in a range of 10:1 to 1:5 in terms of the mass ratio.

The charge transport layer may also contain other known additives.

The formation of the charge transport layer is not particularly limited, and a known forming method is used. For example, a coating film of a coating solution for forming a charge transport layer in which the above-described components are added to a solvent is formed, and the coating film is dried and, as necessary, heated.

Examples of the solvent for preparing the coating solution for forming a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for forming a charge transport layer include typical methods such as a blade coating method, a wire bar coating method, a spray coating method, a dip coating method, a bead coating method, an air knife coating method, and a curtain coating method.

The film thickness of the charge transport layer is set to be, for example, preferably in a range of 5 μm or greater and 50 μm or less and more preferably in a range of 10 μm or greater and 30 μm or less.

### Image Forming Apparatus (and Process Cartridge)

An image forming apparatus according to the present exemplary embodiment includes an electrophotographic photoreceptor; a charging device that contact-charges the surface of the electrophotographic photoreceptor with a DC voltage; an electrostatic latent image forming device that forms an electrostatic latent image on the charged surface of the electrophotographic photoreceptor; a developing device that develops the electrostatic latent image formed on the surface of the electrophotographic photoreceptor with a developer containing a toner to form a toner image; and a transfer device that transfers the toner image to a surface of a recording medium. Further, the electrophotographic photoreceptor for contact charging with a DC voltage according to the present exemplary embodiment is employed as the electrophotographic photoreceptor.

As the image forming apparatus according to the present exemplary embodiment, known image forming apparatuses such as an apparatus including a fixing unit that fixes the toner image transferred to the surface of a recording medium; a direct transfer type apparatus that transfers the toner image formed on the surface of the electrophotographic photoreceptor directly to the recording medium; an intermediate transfer type apparatus that primarily transfers the toner image formed on the surface of the electrophotographic photoreceptor to the surface of the intermediate transfer member and secondarily transfers the toner image transferred to the surface of the intermediate transfer member to the surface of the recording medium; an apparatus including a cleaning unit that cleans the surface of the electrophotographic photoreceptor after the transfer of the toner image and before the charging; an apparatus including a charge erasing unit that erases the charges on the surface of the electrophotographic photoreceptor by applying the charge erasing light to the surface after the transfer of the toner image and before the charging; and an apparatus including an electrophotographic photoreceptor heating member for increasing the temperature of the electrophotographic photoreceptor and decreasing the relative temperature are employed.

In a case of the intermediate transfer type apparatus, the transfer unit is, for example, configured to include an intermediate transfer member having a surface onto which the toner image is transferred, a primary transfer unit primarily transferring the toner image formed on the surface of the electrophotographic photoreceptor to the surface of the intermediate transfer member, and a secondary transfer unit secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

Further, in the image forming apparatus according to the present exemplary embodiment, for example, a portion including the electrophotographic photoreceptor may have a cartridge structure (process cartridge) that is attachable to and detachable from the image forming apparatus, and contact-charges the electrophotographic photoreceptor with the DC voltage. As the process cartridge, for example, a process cartridge including the electrophotographic photoreceptor for contact charging with a DC voltage according to the present exemplary embodiment is preferably used. Further, the process cartridge may include, for example, at least one selected from the group consisting of a charging unit, an electrostatic latent image forming unit, a developing unit, and a transfer unit in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

FIG. 2 is a schematic configuration view showing an example of the image forming apparatus according to the present exemplary embodiment.

As shown in FIG. 2, an image forming apparatus 100 according to the present exemplary embodiment includes a process cartridge 300 including an electrophotographic photoreceptor 7, an exposure device 9 (an example of an electrostatic latent image forming unit), a transfer device 40 (primary transfer device), and an intermediate transfer member 50. Further, in the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). Further, the intermediate transfer member 50, the transfer device 40 (primary transfer device), and the secondary transfer device (not shown) correspond to an example of the transfer unit.

The process cartridge 300 in FIG. 2 integrally supports the electrophotographic photoreceptor 7, a charging device 8 (an example of the charging unit), a developing device 11 (an example of the developing unit), and a cleaning device 13 (an example of the cleaning unit) in a housing. The cleaning device 13 has a cleaning blade (an example of the cleaning member) 131, and the cleaning blade 131 is disposed to come into contact with the surface of the electrophotographic photoreceptor 7. Further, the cleaning member may be a conductive or insulating fibrous member instead of the aspect of the cleaning blade 131, and may be used alone or in combination with the cleaning blade 131.

Further, FIG. 2 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

As the charging device 8, for example, a contact type charger using a conductive or semi-conductive charging roller, a charging brush, a charging film, a charging rubber blade, a charging tube, or the like is used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or greater and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used.

In addition to the cleaning blade type device, a fur brush cleaning type device or a simultaneous development cleaning type device may be employed.

### Transfer Device

Examples of the transfer device 40 include a known transfer charger such as a contact type transfer charger using a belt, a roller, a film, a rubber blade, or the like, or a scorotron transfer charger or a scorotron transfer charger using corona discharge.

### Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

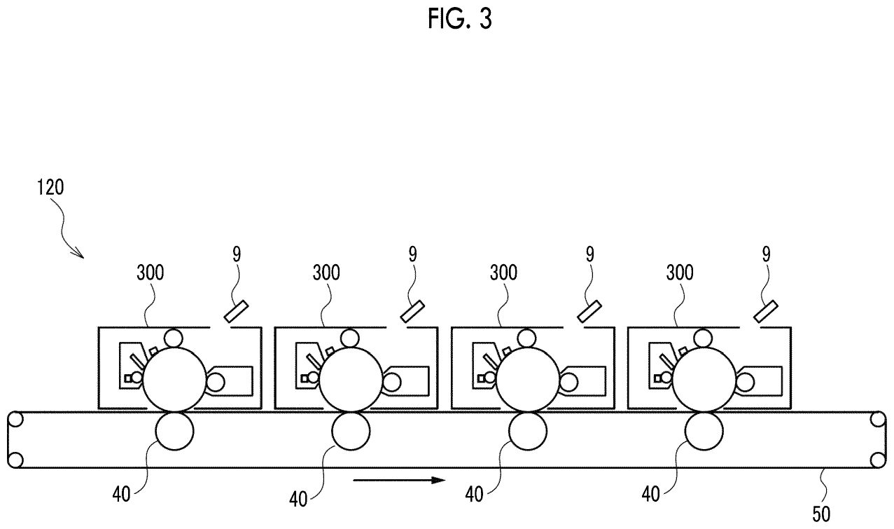

FIG. 3 is a schematic configuration view showing another example of the image forming apparatus according to the present exemplary embodiment.

An image forming apparatus 120 shown in FIG. 3 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. Further, the image forming apparatus 120 has the same configuration as the image forming apparatus 100 except that the image forming apparatus 120 is of a tandem type.

### EXAMPLES

Hereinafter, the electrophotographic photoreceptor according to the present exemplary embodiment will be described in more detail with reference to examples. The materials, the used amounts, the ratios, the treatment procedures, and the like described in the following examples may be appropriately changed without departing from the spirit of the present exemplary embodiment. Therefore, the scope of the electrophotographic photoreceptor of the present exemplary embodiment should not be limitatively interpreted by the specific examples described below.

### Examples 1 to 8 and Comparative Examples 1 to 6

### Preparation of Photoreceptor

### Preparation of Undercoat Layer

100 parts by mass of zinc oxide (manufactured by Tayca Corporation, average particle diameter of 70 nm, specific surface area of 15 m²/g) and 500 parts by mass of toluene are stirred and mixed, and 1.3 parts by mass of a silane coupling agent (KBM503, manufactured by Shin-Etsu Chemical Co., Ltd.) is added thereto, and the mixture is stirred for 2 hours. Thereafter, toluene is distilled off by vacuum distillation and baked at 120° C. for 3 hours, thereby obtaining zinc oxide surface-treated with a silane coupling agent.

110 parts by mass of the surface-treated zinc oxide is stirred and mixed with 500 parts by mass of tetrahydrofuran, a solution in which 0.6 parts by mass of alizarin is dissolved in 50 parts by mass of tetrahydrofuran is added thereto, and the mixture is stirred at 50° C. for 5 hours. Thereafter, zinc oxide to which the alizarin is added is separated by vacuum filtration, and further dried under reduced pressure at 60° C. to obtain zinc oxide with alizarin.

38 parts by mass of a solution obtained by dissolving 60 parts by mass of the zinc oxide with alizarin, 13.5 parts by mass of a curing agent (SUMIDUR 3175, manufactured by Sumitomo Bayer Urethane Co., Ltd., blocked isocyanate), 15 parts by mass of a butyral resin (S-LEC BM-1, manufactured by Sekisui Chemical Co., Ltd.) in 85 parts by mass of methyl ethyl ketone and 25 parts by mass of methyl ethyl ketone are mixed and dispersed by a sand mill for 2 hours using glass beads having a diameter of 1 mmφ, thereby obtaining a dispersion liquid.

0.005 part by mass of dioctyltin dilaurate as a catalyst and 40 parts by mass of silicone resin particles (TOSPEARL 145, manufactured by GE Toshiba Silicone Co., Ltd.) are added to the obtained dispersion liquid, thereby obtaining a coating solution for forming an undercoat layer.

A cylindrical aluminum substrate having a diameter of 30 mm, a length of 340 mm, and a wall thickness of 1 mm is prepared as a conductive substrate and coated with the obtained coating solution for forming an undercoat layer by a dip coating method, the solution is dried and cured at 170° C. for 40 minutes, thereby obtaining an undercoat layer having a thickness of 18.7 μm.

### Preparation of Charge Generation Layer

A mixture of 15 parts by mass of hydroxygallium phthalocyanine having diffraction peaks at positions where Bragg angles (2θ±0.2°) in an X-ray diffraction spectrum using Cuka characteristic X-rays are at least 7.3°, 16.0°, 24.9°, and 28.0° as the charge generation material, 10 parts by mass of a vinyl chloride-vinyl acetate copolymer resin (VMCH, manufactured by Nippon Unicar Company Limited) as a binder resin, and 200 parts by mass of n-butyl acetate is dispersed in a sand mill for 4 hours using glass beads having a diameter of 1 mmφ. 175 parts by mass of n-butyl acetate and 180 parts by mass of methyl ethyl ketone were added to the obtained dispersion liquid and stirred to obtain a coating solution for forming a charge generation layer.

The undercoat layer formed on the cylindrical aluminum substrate in advance is dipped and coated with the obtained coating solution for forming a charge generation layer, and the solution is dried at room temperature (25° C.), thereby forming a charge generation layer having a film thickness of 0.2 μm.

### Preparation of Charge Transport Layer

First, a polycarbonate copolymer (1) is obtained in the following manner.

A flask provided with a phosgene blowing tube, a thermometer, and a stirrer is charged with 106.9 g (0.398 mol) of 1,1-bis(4-hydroxyphenyl)cyclohexane (hereinafter, referred to as “Z”), 24.7 g (0.133 mol) of 4,4′-dihydroxybiphenyl (hereinafter, referred to as “BP”), 0.41 g of hydrosulfite, 825 ml of a 9.1% sodium hydroxide aqueous solution (2.018 mol of sodium hydroxide), and 500 ml of methylene chloride in a nitrogen atmosphere, the mixture is dissolved, stirred, and held in a temperature range of 18° C. or higher and 21° C. or lower, and 76.2 g (0.770 mol) of phosgene is blown for 75 minutes to carry out a phosgenation reaction. After completion of the phosgenation reaction, 1.11 g (0.0075 mol) of p-tert-butylphenol and 54 ml (0.266 mol of sodium hydroxide) of a 25% sodium hydroxide aqueous solution are added to the mixture and stirred, and 0.18 mL (0.0013 mol) of triethylamine is added to the mixture in the middle of the stirring to carry out a reaction at a temperature of 30° C. or higher and 35° C. or lower for 2.5 hours. The separated methylene chloride phase is washed with an acid and water until inorganic salts and amines are eliminated, and methylene chloride is removed, thereby obtaining a polycarbonate copolymer (1). The ratio of the constitutional units of Z and BP in the polycarbonate is 75:25 in terms of the molar ratio.

Next, 25 parts by mass of N,N′-diphenyl-N,N′-bis(3-methylphenyl)-[1,1′]biphenyl-4,4′-diamine (TPD), 20 parts by mass of a compound represented by Structural Formula (A), and 55 parts by mass of the polycarbonate copolymer (1) (viscosity average molecular weight: 50000) as a binder resin are added to and dissolved in 560 parts by mass of tetrahydrofuran and 240 parts by mass of toluene, thereby obtaining a coating solution for a charge transport layer. The charge generation layer is coated with the coating solution, and the solution is dried at 135° C. for 45 minutes, thereby forming a charge transport layer having a film thickness of 20 μm.

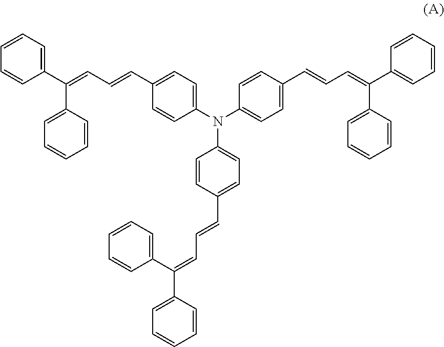 [SMILES: C(/C=C/c1ccc(N(c2ccc(/C=C/C=C(c3ccccc3)c3ccccc3)cc2)c2ccc(/C=C/C=C(c3ccccc3)c3ccccc3)cc2)cc1)=C(c1ccccc1)c1ccccc1]

### Preparation of Protective Layer

The compound listed in Table 1 prepared in the amount listed in Table 1 as the compound containing a reactive charge transport material and a hydroxy group, the compound listed in Table 1 prepared in the amount listed in Table 1 as the compound containing no hydroxy group and a benzene ring, and 4.4 parts by mass of a benzoguanamine resin (NIKALAC BL-60, manufactured by Sanwa Chemical Industrial Co., Ltd.) serving as a curable resin that is a reactive group-containing non-charge transport material are added to 220 parts by mass of the solvent listed in Table 1, mixed, and dissolved in the solvent, and 0.1 parts by mass of NACURE 5225 (manufactured by King Industries, Inc.) is added to the solution as a curing catalyst, thereby obtaining a coating solution for forming a surface protective layer.

The charge transport layer is dipped in and coated with the coating solution for forming a surface protective layer, the solution is air-dried at room temperature (25° C.) for 30 minutes, heated at an oxygen concentration of 110 ppm from room temperature to the drying temperature (reaching temperature) listed in Table 1 in a nitrogen stream, held for the drying time (holding time) listed in Table 1, subjected to a heat treatment, and cured. Thereafter, a surface protective layer having a film thickness of 10 μm is formed. As described above, each electrophotographic photoreceptor is obtained.

### Evaluation of Property of Suppressing Image Deletion

A DocuCentre-V C2263 (manufactured by FUJIFILM Business Innovation Corporation), which accommodates an electrostatic charge image developer, is prepared as an image forming apparatus, the prepared electrophotographic photoreceptor is set, 100000 sheets of A4 paper are fed through the image forming apparatus, and the paper is allowed to stand at a high temperature and a high humidity (28° C. and 85% RH) for 12 hours or longer. 10 sheets of halftone images (image density of 30%) are output after the standing, and image deletion (toner void) is evaluated. The evaluation standards are shown below.

A: Image deletion is not found.

B: The degree of image deletion is not problematic in terms of the image quality.

C: The degree of image deletion is problematic in terms of the image quality.

### Evaluation of Property of Suppressing Abrasion

The film thickness of the prepared electrophotographic photoreceptor is measured with an eddy current film thickness meter before and after 100000 sheets of A4 paper are fed in the evaluation of the property of suppressing image deletion described above, a difference in average film thickness before and after the feeding of the paper is divided by the traveling amount, and the average abrasion rate is calculated.

The property of suppressing abrasion is excellent as the value of the average abrasion rate (nm/kcyc, the amount of abrasion per feeding 1000 sheets of A4 paper) decreases. Further, the value of the average abrasion rate is, for example, preferably less than 4.0 nm/kcyc and more preferably less than 3.0 nm/kcyc.

Hereinafter, the details of each example and the evaluation results are collectively listed in Table 1.

TABLE 1

| | Surface protective layer | | | | | | | | | | | |
|---|---|---|---|---|---|---|---|---|---|---|---|---|
| | | | | | Compound | | | | | Value of peak | | |
| | | | | | containing no | | | | | area of | | |
| | Compound containing | | | | hydroxy | | | | | hydroxy group/ | | |
| | reactive charge | | | | group and | | | | | peak area of | | |
| | transport material and | | | | having benzene | | | | | benzene ring | | |
| | hydroxy group | | | | ring structure | | | | | structure | Evaluation results | |
| | | Used | | Used | | Used | | | | measured by | | Property of |
| | | amount | | amount | | amount | | Drying | Drying | FT-IR | Average | suppressing |
| | | (parts by | | (parts by | | (parts by | | temperature | time | spectroscopy | abrasion rate | image |
| | Type | mass) | Type | mass) | Type | mass) | Solvent | (° C.) | (min) | ATR method | (nm/kcyc) | deletion |
| Example 1 | H-1 | 45 | H-3 | 45 | B-1 | 10 | 2-Propanol | 160 | 30 | 0.15 | 2.5 | A |
| Example 2 | H-1 | 45 | H-3 | 45 | B-1 | 10 | 2-Propanol | 155 | 30 | 0.35 | 2.6 | B |
| Example 3 | H-1 | 45 | H-3 | 45 | B-1 | 10 | 2-Propanol | 150 | 45 | 0.36 | 3.0 | B |
| Example 4 | H-1 | 40 | H-3 | 40 | B-1 | 20 | 2-Propanol | 160 | 30 | 0.10 | 3.0 | B |
| Example 5 | H-2 | 45 | H-3 | 45 | B-1 | 10 | 2-Propanol | 160 | 30 | 0.15 | 2.5 | A |
| Example 6 | H-2 | 45 | H-3 | 45 | B-1 | 10 | 2-Propanol | 155 | 30 | 0.35 | 2.6 | B |
| Example 7 | H-2 | 45 | H-3 | 45 | B-1 | 10 | 2-Propanol | 150 | 45 | 0.36 | 3.0 | B |
| Example 8 | H-2 | 40 | H-3 | 40 | B-1 | 20 | 2-Propanol | 160 | 30 | 0.10 | 3.0 | B |
| Comparative | H-1 | 45 | H-3 | 45 | B-1 | 10 | 2-Propanol | 150 | 15 | 0.37 | 3.0 | C |
| Example 1 | | | | | | | | | | | | |
| Comparative | H-1 | 45 | H-3 | 45 | B-1 | 10 | 2-Propanol | 145 | 30 | 0.40 | 5.0 | A |
| Example 2 | | | | | | | | | | | | |
| Comparative | H-1 | 45 | H-3 | 45 | B-1 | 10 | 2-Propanol | 170 | 30 | 0.05 | 4.0 | B |
| Example 3 | | | | | | | | | | | | |
| Comparative | H-1 | 45 | H-3 | 45 | B-1 | 10 | 2-Propanol | 170 | 30 | 0.05 | 4.0 | B |
| Example 4 | | | | | | | | | | | | |
| Comparative | H-1 | 50 | H-3 | 50 | — | — | 2-Propanol | 170 | 30 | 0.40 | 5.0 | A |
| Example 5 | | | | | | | | | | | | |
| Comparative | H-1 | 90 | — | — | B-1 | 10 | 2-Propanol | 160 | 30 | 0.50 | 5.5 | B |
| Example 6 | | | | | | | | | | | | |

The details of the abbreviations listed in Table 1 are as follows.
H-1: compound shown below
H-2: compound shown below
H-3: compound shown below

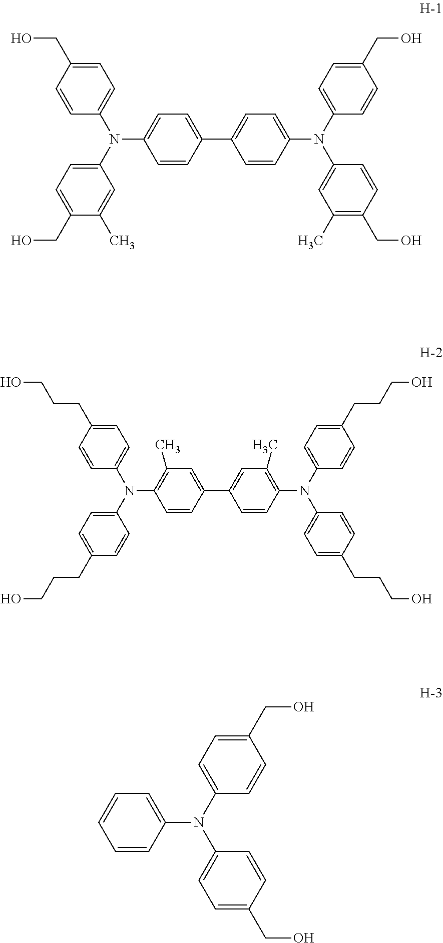 [SMILES: Cc1cc(N(c2ccc(CO)cc2)c2ccc(-c3ccc(N(c4ccc(CO)cc4)c4ccc(CO)c(C)c4)cc3)cc2)ccc1CO ; Cc1cc(-c2ccc(N(c3ccc(CCCO)cc3)c3ccc(CCCO)cc3)c(C)c2)ccc1N(c1ccc(CCCO)cc1)c1ccc(CCCO)cc1 ; OCc1ccc(N(c2ccccc2)c2ccc(CO)cc2)cc1]

B-1: compound shown below

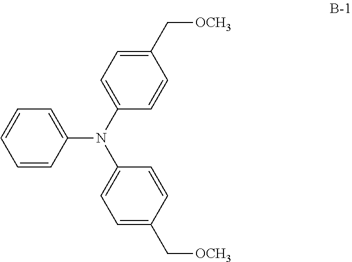 [SMILES: COCc1ccc(N(c2ccccc2)c2ccc(COC)cc2)cc1]

As listed in Table 1, the electrophotographic photoreceptors of the examples are excellent in both the property of suppressing abrasion and the property of suppressing image deletion as compared with the electrophotographic photoreceptors of the comparative examples.

(((1))) An electrophotographic photoreceptor for contact charging with a DC voltage, comprising:
a conductive substrate;
an undercoat layer provided on the conductive substrate;
a charge generation layer provided on the undercoat layer;
a charge transport layer provided on the charge generation layer; and
a surface protective layer provided on the charge transport layer,
wherein the surface protective layer is a cured film of a composition containing a reactive charge transport material and contains a hydroxy group and a benzene ring structure, and a value of a peak area of the hydroxy group/a peak area of the benzene ring structure that are measured by an attenuated total reflection method of infrared spectroscopy, is greater than 0.05 and 0.36 or less.

(((2))) The electrophotographic photoreceptor for contact charging with a DC voltage according to (((1))),
wherein the surface protective layer is a cured film of a composition that contains a compound containing a hydroxy group and a compound containing no hydroxy group and having a benzene ring structure.

(((3))) The electrophotographic photoreceptor for contact charging with a DC voltage according to (((2))),
wherein the compound containing a hydroxy group is the reactive charge transport material.

(((4))) The electrophotographic photoreceptor for contact charging with a DC voltage according to (((2))) or (((3)
wherein the compound containing a hydroxy group is a compound having a triarylamine structure.

(((5))) The electrophotographic photoreceptor for contact charging with a DC voltage according to any one of (((2))) to (((4))),
wherein the compound containing no hydroxy group and having a benzene ring structure is a compound having a triarylamine structure.

((6))) The electrophotographic photoreceptor for contact charging with a DC voltage according to any one of (((2))) to (((5))),
wherein a value of a mass ratio MH/MB of a content MH of the compound containing a hydroxy group to a content MB of the compound containing no hydroxy group and having a benzene ring structure in the composition is 5 or greater and 20 or less.

(((7))) The electrophotographic photoreceptor for contact charging with a DC voltage according to any one of (((1) to (6)),
wherein the surface protective layer contains no carboxy group.

(((8))) The electrophotographic photoreceptor for contact charging with a DC voltage according to any one of (((1))) to (((7)),
wherein the surface protective layer contains no silicon atom.

(((9))) A process cartridge comprising:
the electrophotographic photoreceptor for contact charging with a DC voltage according to any one of (((1))) to ((8))),
wherein the process cartridge is attachable to and detachable from an image forming apparatus and contact-charges the electrophotographic photoreceptor with a DC voltage.

(((10))) An image forming apparatus comprising:
the electrophotographic photoreceptor for contact charging with a DC voltage according to any one of (((1))) to (((8)));
a charging device that contact-charges a surface of the electrophotographic photoreceptor with a DC voltage;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor for contact charging with a DC voltage, comprising:
a conductive substrate;
an undercoat layer provided on the conductive substrate;
a charge generation layer provided on the undercoat layer;
a charge transport layer provided on the charge generation layer; and
a surface protective layer provided on the charge transport layer,
wherein the surface protective layer is a cured film of a composition containing a reactive charge transport material and contains a hydroxy group and a benzene ring structure, and a value of a peak area of the hydroxy group/a peak area of the benzene ring structure that are measured by an attenuated total reflection method of infrared spectroscopy, is greater than 0.05 and 0.36 or less.

2. The electrophotographic photoreceptor for contact charging with a DC voltage according to claim 1,
wherein the surface protective layer is a cured film of a composition that contains a compound containing a hydroxy group and a compound containing no hydroxy group and having a benzene ring structure.

3. The electrophotographic photoreceptor for contact charging with a DC voltage according to claim 2,
wherein the compound containing a hydroxy group is the reactive charge transport material.

4. The electrophotographic photoreceptor for contact charging with a DC voltage according to claim 2,
wherein the compound containing a hydroxy group is a compound having a triarylamine structure.

5. The electrophotographic photoreceptor for contact charging with a DC voltage according to claim 2,
wherein the compound containing no hydroxy group and having a benzene ring structure is a compound having a triarylamine structure.

6. The electrophotographic photoreceptor for contact charging with a DC voltage according to claim 2,
wherein a value of a mass ratio MH/MB of a content MH of the compound containing a hydroxy group to a content MB of the compound containing no hydroxy group and having a benzene ring structure in the composition is 5 or greater and 20 or less.

7. The electrophotographic photoreceptor for contact charging with a DC voltage according to claim 1,
wherein the surface protective layer contains no carboxy group.

8. The electrophotographic photoreceptor for contact charging with a DC voltage according to claim 1,
wherein the surface protective layer contains no silicon atom.

9. A process cartridge comprising:
the electrophotographic photoreceptor for contact charging with a DC voltage according to claim 1,
wherein the process cartridge is attachable to and detachable from an image forming apparatus and contact-charges the electrophotographic photoreceptor with a DC voltage.

10. A process cartridge comprising:
the electrophotographic photoreceptor for contact charging with a DC voltage according to claim 2,
wherein the process cartridge is attachable to and detachable from an image forming apparatus and contact-charges the electrophotographic photoreceptor with a DC voltage.

11. A process cartridge comprising:
the electrophotographic photoreceptor for contact charging with a DC voltage according to claim 3,
wherein the process cartridge is attachable to and detachable from an image forming apparatus and contact-charges the electrophotographic photoreceptor with a DC voltage.

12. A process cartridge comprising:
the electrophotographic photoreceptor for contact charging with a DC voltage according to claim 4,
wherein the process cartridge is attachable to and detachable from an image forming apparatus and contact-charges the electrophotographic photoreceptor with a DC voltage.

13. A process cartridge comprising:
the electrophotographic photoreceptor for contact charging with a DC voltage according to claim 5,
wherein the process cartridge is attachable to and detachable from an image forming apparatus and contact-charges the electrophotographic photoreceptor with a DC voltage.

14. A process cartridge comprising:
the electrophotographic photoreceptor for contact charging with a DC voltage according to claim 6,
wherein the process cartridge is attachable to and detachable from an image forming apparatus and contact-charges the electrophotographic photoreceptor with a DC voltage.

15. A process cartridge comprising:
the electrophotographic photoreceptor for contact charging with a DC voltage according to claim 7,
wherein the process cartridge is attachable to and detachable from an image forming apparatus and contact-charges the electrophotographic photoreceptor with a DC voltage.

16. A process cartridge comprising:
the electrophotographic photoreceptor for contact charging with a DC voltage according to claim 8,
wherein the process cartridge is attachable to and detachable from an image forming apparatus and contact-charges the electrophotographic photoreceptor with a DC voltage.

17. An image forming apparatus comprising:
the electrophotographic photoreceptor for contact charging with a DC voltage according to claim 1;
a charging device that contact-charges a surface of the electrophotographic photoreceptor with a DC voltage;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

18. An image forming apparatus comprising:
the electrophotographic photoreceptor for contact charging with a DC voltage according to claim 2;
a charging device that contact-charges a surface of the electrophotographic photoreceptor with a DC voltage;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

19. An image forming apparatus comprising:
the electrophotographic photoreceptor for contact charging with a DC voltage according to claim 3;
a charging device that contact-charges a surface of the electrophotographic photoreceptor with a DC voltage;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

20. An image forming apparatus comprising:
the electrophotographic photoreceptor for contact charging with a DC voltage according to claim 4;
a charging device that contact-charges a surface of the electrophotographic photoreceptor with a DC voltage;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
